(19) United States
(12) Patent Application Publication
(10) Pub. No.: US 2024/0246639 A1
(43) Pub. Date: Jul. 25, 2024

(54) MECHANICAL JOINTS AND PROCESS FOR USING SAME

(71) Applicant: SOFEC, INC., HOUSTON, TX (US)

(72) Inventor: QUOC ANH DANG, Cypress, TX (US)

(73) Assignee: SOFEC, INC., Houston, TX (US)

(21) Appl. No.: 18/416,701

(22) Filed: Jan. 18, 2024

Related U.S. Application Data
(60) Provisional application No. 63/439,949, filed on Jan. 19, 2023.

(51) Int. Cl. B63B 21/50; B63B 21/04; B63B 21/20

(52) U.S. Cl. CPC B63B 21/507; B63B 21/04; B63B 21/20

(57) ABSTRACT

Mechanical joints and processes for using same. The mechanical joint can include a gimbal table that can define a first and second bearing surface and include a first and second trunnion extending from a pair of opposing sides. The arm can include a third and fourth trunnion disposed toward a second end thereof. The third and fourth trunnion can be aligned along a first axis and the first and second trunnion can be aligned along a second axis. The first and second axes can be substantially orthogonal or substantially perpendicular to one another. The third trunnion and the first bearing surface and the fourth trunnion and the second bearing surface, respectively, can be engaged with one another. The arm can be rotatable relative to the gimbal table about the first axis, and at least a portion of the arm can be disposed through an aperture defined by the gimbal table.

### CROSS-REFERENCE TO RELATED APPLICATION

This application claims priority to U.S. Provisional Patent Application No. 63/439,949, filed on Jan. 19, 2023, which is incorporated by reference herein.

### FIELD

Embodiments described generally relate to mechanical joints. More particularly, such embodiments relate to mechanical joints for use in connecting a first member to a second member, e.g., for connecting a link arm or a mooring leg to a floating body at an offshore site, and processes for using same.

### BACKGROUND

In the offshore energy industry, it is often necessary or desirable to have two members mechanically linked to one another in a manner that allows articulation of a first member relative to a second member about two axes while simultaneously transmitting loads from the first member to the second member. This is typically accomplished with a mechanical joint. For example, chain mooring legs can be attached to a floating body via a mechanical joint assembly that is configured to limit out of plane bending of the chain mooring legs. In another example, u-joints can be used to connect a vessel support structure to a yoke in an offshore mooring system. These mechanical joints tend to be large, expensive, and difficult to handle.

There is a need, therefore, for improved mechanical joints and process for using same.

### SUMMARY

Mechanical joints configured to provide an articulated connection between a first member and a second member and processes for using same are provided. In some embodiments, the mechanical joint can include a gimbal table that can define an aperture therethrough. An upper surface of the gimbal table can define a first bearing surface and a second bearing surface on a first pair of opposing sides of the gimbal table. A first trunnion and a second trunnion can be disposed on a second pair of opposing sides of the gimbal table. The mechanical joint can also include an arm having a first end and a second end. A third trunnion and a fourth trunnion can each be disposed toward the second end of the arm. The third trunnion and the fourth trunnion can be aligned with a first axis. The first trunnion and the second trunnion can be aligned with a second axis. The first axis and the second axis can be substantially orthogonal or substantially perpendicular with respect to one another. The third trunnion and the first bearing surface can be engaged with one another. The fourth trunnion and the second bearing surface can be engaged with one another. The arm can be rotatable relative to the gimbal table about the first axis. At least a portion of the arm can be disposed through the aperture defined by the gimbal table.

In other embodiments, a mechanical joint configured to provide an articulated connection between a first member and a second member can include a first bearing block and a second bearing block configured to be disposed on the first member. The mechanical joint can also include a gimbal table that can define an aperture therethrough. An upper surface of the gimbal table can define a first bearing surface and a second bearing surface on a first pair of opposing sides of the gimbal table. A first trunnion and a second trunnion can be disposed on a second pair of opposing sides of the gimbal table. The mechanical joint can also include an arm having a first end and a second end. A third trunnion and a fourth trunnion can each be disposed toward the second end of the arm. The mechanical joint can also include a first bearing cap that can be configured to be engaged with the third trunnion and can be configured to be attached to the upper surface of the gimbal table. The mechanical joint can also include a second bearing cap that can be configured to be engaged with the fourth trunnion and can be configured to be attached to the upper surface of the gimbal table. The mechanical joint can also include a third bearing cap that can be configured to be secured to the first bearing block. The mechanical joint can also include a fourth bearing cap that can be configured to be secured to the second bearing block. The third trunnion and the fourth trunnion can be aligned with a first axis. The first trunnion and the second trunnion can be aligned with a second axis. The first axis and the second axis can be substantially orthogonal or substantially perpendicular with respect to one another. The third trunnion and the first bearing surface can be engaged with one another. The fourth trunnion and the second bearing surface can be engaged with one another. The arm can be rotatable relative to the gimbal table about the first axis. At least a portion of the arm can be disposed through the aperture defined by the gimbal table. The first trunnion can be configured to rotatively engage with the first bearing block and the second trunnion can be configured to rotatively engage with the second bearing block.

In some embodiments, a process for connecting a first member to a second member can include providing a mechanical joint. The mechanical joint can include a first bearing block and a second bearing block configured to be disposed on the first member. The mechanical joint can also include a gimbal table that can define an aperture therethrough. An upper surface of the gimbal table can define a first bearing surface and a second bearing surface on a first pair of opposing sides of the gimbal table. A first trunnion and a second trunnion can be disposed on a second pair of opposing sides of the gimbal table. The mechanical joint can also include an arm having a first end and a second end. A third trunnion and a fourth trunnion can each be disposed toward the second end of the arm. The mechanical joint can also include a first bearing cap that can be engaged with the third trunnion and can be attached to the upper surface of the gimbal table. The mechanical joint can also include a second bearing cap that can be engaged with the fourth trunnion and can be attached to the upper surface of the gimbal table. The mechanical joint can also include a third bearing cap secured to the first bearing block. The mechanical joint can also include a fourth bearing cap secured to the second bearing block. The third trunnion and the fourth trunnion can be aligned with a first axis. The first trunnion and the second trunnion can be aligned with a second axis. The first axis and the second axis can be substantially orthogonal or substantially perpendicular with respect to one another. The third trunnion and the first bearing surface can be engaged with one another. The fourth trunnion and the second bearing surface can be engaged with one another. The arm can be rotatable relative to the gimbal table about the first axis. At least a portion of the arm can be disposed through the aperture defined by the gimbal table. The first trunnion can be configured to rotatively engage with the first bearing block and the second trunnion can be configured to rotatively engage with the second bearing block. The process can also include installing the mechanical joint on the first member.

### BRIEF DESCRIPTION OF THE DRAWINGS

The various aspects and advantages of the preferred embodiment of the present invention will become apparent to those skilled in the art upon an understanding of the following detailed description of the invention, read in light of the accompanying drawings which are made a part of this specification.

FIG. 1 depicts a perspective view of an illustrative mechanical joint that includes a gimbal table and an arm, according to one or more embodiments described.

FIG. 2 depicts an exploded view of the mechanical joint shown in FIG. 1 that further includes a plurality of bushings, according to one or more embodiments described.

FIG. 3 depicts a plan view of the gimbal table shown in FIGS. 1 and 2.

FIG. 4 depicts a first side elevation view of the gimbal table shown in FIGS. 1 and 2.

FIG. 5 depicts a second side elevation view of the gimbal table shown in FIGS. 1 and 2.

FIG. 6 depicts a side elevation view of the arm shown in FIGS. 1 and 2.

FIG. 7 depicts a partially exploded view of the mechanical joint depicted in FIG. 2 that further includes a first and a second bearing block and corresponding bearing caps, according to one or more embodiments described.

FIG. 8 depicts a turret mooring system that includes a plurality of mechanical joints linking a first member to a second member, according to one or more embodiments.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

It should also be understood that the phrases “disposed therein”, “disposed within”, and other similar phrases, when describing a component, e.g., an arm or ball, describe the component as being partially disposed therein/within or completely disposed therein/within. For example, if the component is a ball disposed on the end of an arm that can be disposed within a socket, the phrase “the ball can be disposed within the socket” means the ball can be disposed partially within the socket or completely within the socket.

The terms “rotate”, “rotation”, “rotatable”, and “rotating” mean unlimited or partial rotation of a body about an axis of rotation.

The terms “orthogonal” and “orthogonally” refer to two lines or vectors that are not coplanar and therefore do not intersect but can appear to be perpendicular when viewed from a particular angle. For example, a first line being orthogonal to a second line, the first line can lie in a first plane and the second line can lie in a second plane, where the first and second planes are parallel with respect to one another and the first line and the second line are oriented at 90 degrees with respect to one another when viewed along an axis that is normal to the first and second planes. Further is should be understood that the term “substantially” when used in the context of “substantially orthogonal” means the first and second line are orientated at angles of about 80 degrees, about 83 degrees, about 85 degrees, about 87 degrees, or about 89 degrees to, about 91 degrees, about 93 degrees, about 95 degrees, about 97 degrees, or about 100 degrees with respect to one another when viewed along an axis that is normal to the first and second planes.

The terms “perpendicular” and “perpendicularly”, as used herein, refer to two lines or vectors that are coplanar and, therefore, do intersect one another at a 90 degree angle. Further, the term “substantially” when used in the context of “substantially perpendicular” means a first line and a second line are orientated at angles of about 80 degrees, about 83 degrees, about 85 degrees, about 87 degrees, or about 89 degrees to, about 91 degrees, about 93 degrees, about 95 degrees, about 97 degrees, or about 100 degrees with respect to one another. Further, the term “substantially” when used in the context of “substantially parallel” means an axis and a plane (e.g., the surface of a body of water) are orientated at angles of about 160 degrees, about 165 degrees, about 170 degrees, about 175 degrees, or about 180, or about 185 degrees, or about 190 degrees, or about 195 degrees, or about 200 degrees with respect to one another.

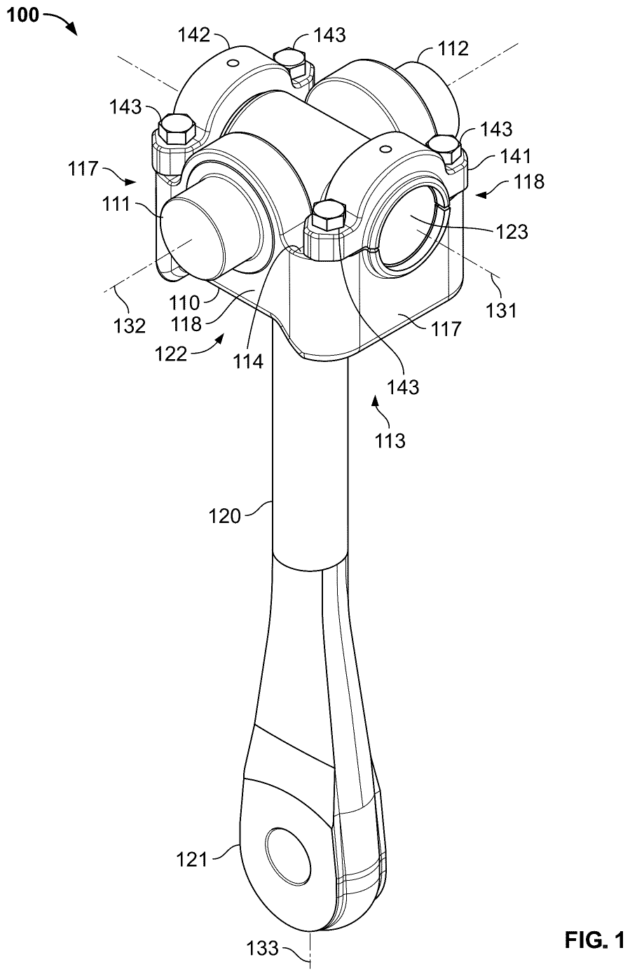

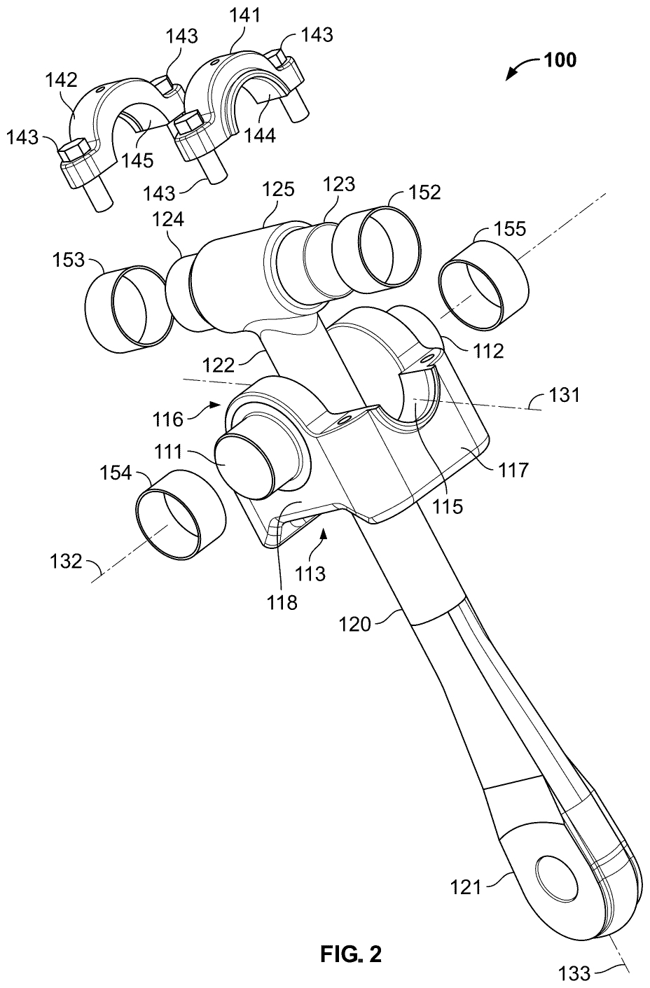

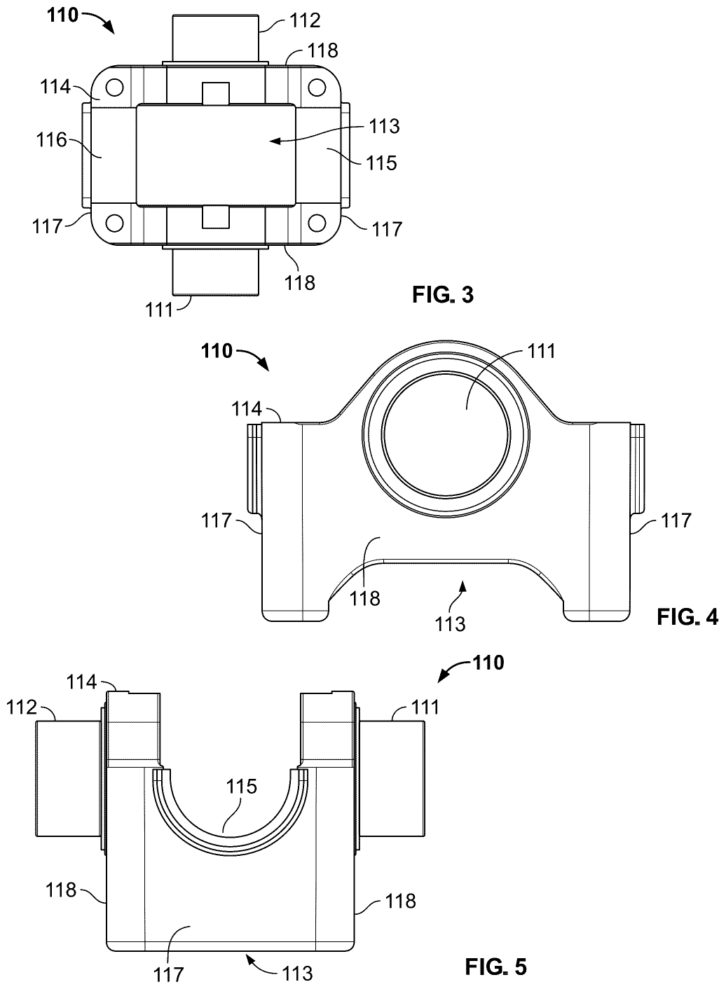

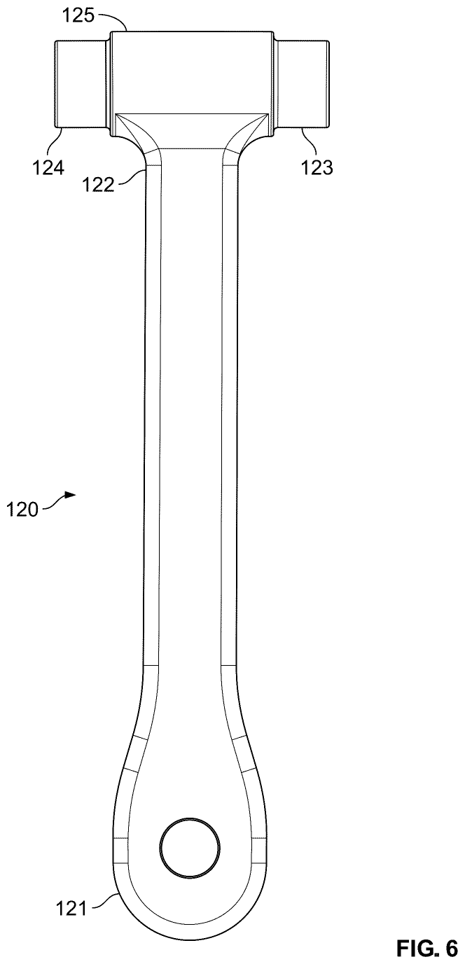

FIG. 1 depicts a perspective view of an illustrative mechanical joint 100 that includes a gimbal table 110 and an arm 120, according to one or more embodiments. FIG. 2 depicts an exploded view of the mechanical joint 100 shown in FIG. 1 that further includes a plurality of bushings 152, 153, 154, and 155, according to one or more embodiments. FIG. 3 depicts a plan view of the gimbal table 110 of the mechanical joint 100 shown in FIGS. 1 and 2. FIG. 4 depicts a first side elevation view of the gimbal table 110 of the mechanical joint 100 shown in FIGS. 1 and 2 looking toward side 118. FIG. 5 depicts a second side elevation of the gimbal table 110 of the mechanical joint 100 shown in FIGS. 1 and 2 looking toward side 117. FIG. 6 depicts a side elevation view of the arm 120 of the mechanical joint 100 depicted in FIGS. 1 and 2.

Referring to FIGS. 1-6 collectively, in some embodiments, the gimbal table 110 can define an aperture 113 therethrough and an upper surface 114 that can define a first bearing surface 115 and a second bearing surface 116. In some embodiments, the first bearing surface 115 and the second bearing surface 116 can each be configured to engage with a corresponding surface, for example a trunnion to support a load or force. In some embodiments, the first bearing surface 115 and the second bearing surface 116 can each be configured to rotatively engage with the corresponding surface such that the corresponding surface can rotate with respect to the first bearing surface 115 and/or the second bearing surface 116 while supporting the load or force. In other embodiments, the first bearing surface 115 and/or the second bearing surface 116 can be configured such that the corresponding surface does not rotate with respect to the first bearing surface and/or the second bearing surface while supporting the load or force. The aperture 113 can have any desired cross-sectional shape or combination of cross-sectional shapes. In some embodiments, the aperture can be circular or any suitable polygonal shape, e.g., rectangular.

In some embodiments, the first bearing surface 115 and the second bearing surface 116 can be disposed, formed, or otherwise located on a first pair of opposing sides 117 of the gimbal table 110. In some embodiments, the first bearing surface 115, the second bearing surface 116, or both can be curved. For example, the first bearing surface 115, the second bearing surface 116, or both can curve toward a longitudinal axis therebetween. In one or more embodiments, the first bearing surface 115, the second bearing surface 116, or both can be an inverse or concave arc or ellipse, for example. The first bearing surface 115, the second bearing surface 116, or both can curve toward a longitudinal axis therebetween having any suitable curvature or combination of curvatures. Illustrative curvatures can include, but are not limited to, radial curves, elliptical curves such as a circular curve, catenary curves, parabolic curves, simple curves, or any combination thereof. In some embodiments, the first bearing surface 115 and the second bearing surface 116 can have a semi-circular cross-section when viewed along a first axis 131. In such embodiment, a central axis of the first bearing surface 115 and a central axis of the second bearing surface 116 can be aligned or colinear with the first axis 131. In other embodiments, the first bearing surface 115 and the second bearing surface 116 can independently be configured with a non-circular shape or non-circular cross-section when viewed along the first axis 131. In such embodiments, the first bearing surface 115 and the second bearing surface 116 can have a non-circular cross-sectional shape, for example an oval, or ellipse-shaped cross-section, a triangular shaped cross-section, a rectangular- shaped cross-section, a pentagonal-shaped cross-section, or any other non-circular cross-section when viewed along the second axis 132.

The mechanical joint 100 can also include a first trunnion 111 and a second trunnion 112. The first trunnion 111 and the second trunnion 112 can be disposed, formed, or otherwise located on a second set of opposing sides 118 of the gimbal table 110. The first trunnion 111 and the second trunnion 112 can extend from the second set of opposing sides 118. In some embodiments, the first trunnion 111 and the second trunnion 112 can be aligned along a second axis 132. In some embodiments, the first trunnion 111 and the second trunnion 112 can have a cylindrical shape. In such embodiments, a central axis of the first trunnion 111 and a central axis of the second trunnion 112 can be aligned or colinear with the second axis 132. In some embodiments, the first trunnion 111 and the second trunnion 112 can be configured to rotatively engage with a pair of support members, e.g., bearing blocks, disposed on or connected to a first member, such that the first trunnion 111, the second trunnion 112, and the gimbal table 110 can rotate relative to the first member about the second axis 132.

The arm 120 can have a first end 121 and a second end 122. The first end 121 of the arm 120 can be configured to be attached to a second member, e.g., a mooring leg or a segment of chain. In some embodiments, the mechanical joint 100 can include a third trunnion 123 and a fourth trunnion 124. In some embodiments, the third trunnion 123 and the fourth trunnion 124 can be rigidly connected to the second end 122 of the arm 120. In some embodiments, the third trunnion 123 and the fourth trunnion 124 can be opposed to one another and can be configured to be perpendicular with a longitudinal axis 133 of the arm 120. The third trunnion 123 and the fourth trunnion 124 can be configured to engage with the first bearing surface 115 and the second bearing surface 116, respectively, defined by the upper surface 114 of the gimbal table 110. The third trunnion 123 and the fourth trunnion 124 can be colinear or aligned with the first axis 131 when the third trunnion 123 and the fourth trunnion 124 engage the first bearing surface 115 and the second bearing surface 116, respectively.

In some embodiments, a central axis of the third trunnion 123 and a central axis of the fourth trunnion 124 can be aligned or colinear with the first axis 131 when the third trunnion 123 and the fourth trunnion 124 engage the first bearing surface 115 and the second bearing surface 116, respectively. In some embodiments, the third trunnion 123 and the fourth trunnion 124 can each have a cylindrical shape or a circular outer cross-section when engaged with the first and second bearing surfaces 115, 116, respectively, and viewed along the first axis 131. In some embodiments, the third trunnion 123 and the fourth trunnion 124 can be configured to rotatively engage with the first bearing surface 115 and the second bearing surface 116, respectively, such that the third trunnion 123, the fourth trunnion 124 and the arm 120 can rotate relative to the gimbal table 110 about the first axis 131.

In other embodiments, the third trunnion 123 and the fourth trunnion 124 can each be configured with a non-cylindrical or non-circular outer cross-section when viewed along the second axis 132. In such embodiments, the third trunnion 123 and the fourth trunnion 124 can have a non-circular cross-sectional shape, for example an oval, or non-circular ellipse-shaped cross-section, a triangular shaped cross-section, a rectangular-shaped cross-section, a pentagonal-shaped cross-section, or any other non-circular cross-section when engaged with the first and second bearing surfaces 115, 116, respectively, and viewed along the first axis 131. In such embodiments, the third trunnion 123 and the fourth trunnion 124 can be configured to engage with the first bearing surface 115 and the second bearing surface 116 such that the third trunnion 123 and the fourth trunnion 124 do not rotate relative to the gimbal table 110 about the first axis 131. In some embodiments, the first bearing surface 115 and the second bearing surface 116 can have a surface profile that corresponds to and can be configured to receive the third and fourth trunnions 123, 124, respectively.

In some embodiments, the arm 120 can include a connection link 125 disposed toward the second end 122 of the arm 120. In some embodiments, the connection link 125 can be rigidly attached to the arm 120 at the second end 122 thereof. In some embodiments, the connection link 125 can have a central axis that can be perpendicular to the longitudinal axis of the arm 133 and aligned with or colinear with the first axis 131 when the third trunnion 123 and the fourth trunnion 124 engage the first bearing surface 115 and the second bearing surface 116, respectively. In some embodiments, the third trunnion 123 and the fourth trunnion 124 can be disposed on or be integral with the connection link 125. In some embodiments, the third trunnion 123 and the fourth trunnion 124 can be rigidly or fixedly connected to the arm 120 toward the second end 122 of the arm 120 via the connection link 125.

In other embodiments, the arm 120 can define a bore through the arm 120 at the second end 122 thereof. In some embodiments, the bore can be cylindrical-shaped, i.e., have a circular cross-section, such that the connection link 125 can be disposed through the bore defined by the arm 120. In such embodiments, the arm 120 can rotate relative to the connection link 125, the third trunnion 123, the fourth trunnion 124 and the gimbal table 110 about the first axis 131. In other embodiments, the bore that can optionally be defined by the arm 120 at the second end 122 thereof can have a non-circular cross-sectional shape, for example an oval, or ellipse-shaped cross-section, a triangular shaped cross-section, a rectangular-shaped cross-section, a pentagonal-shaped cross-section, or any other non-circular cross-section. In such embodiments, the arm 120 and the connection link 125 can be configured to not rotate relative to one another. In such embodiments, the third trunnion 123, the fourth trunnion 124, the first bearing surface 115 and the second bearing surface 116 can each cylindrically shaped and configured to rotate with respect to one another.

In some embodiments, the first axis 131 and the second axis 132 can be orthogonal or substantially orthogonal with respect to one another. In some other embodiments, the first axis 131 and the second axis 132 can be perpendicular or substantially perpendicular with respect to one another. In some embodiments, the first axis 131 and the second axis 132 can lie in the same plane and intersect one another at right angles with respect to one another. In other embodiments, the first axis 131 and the second axis 132 can lie in different planes with respect to one another and can be orthogonal or substantially orthogonal with respect to one another. In some embodiments, the third trunnion 123 and the first bearing surface 115 can be engaged or rotatively engaged with one another. In some embodiments, the second bearing surface 116 and the fourth trunnion 124 can be engaged or rotatively engaged with one another.

In some embodiments, the first bearing surface 115 and the third trunnion 123 can be configured to rotate with respect to one another, the second bearing surface 116 and the fourth trunnion 124 can be configured to rotate with respect to one another, the third trunnion 123 and the fourth trunnion 124 can be rigidly connected to the connection link 125, and the arm 120 can be rigidly connected to the connection link 125. In some other embodiments, the first bearing surface 115 and the third trunnion 123 can be configured to not rotate with respect to one another, the second bearing surface 116 and the fourth trunnion 124 can be configured to not rotate with respect to one another, the third trunnion 123 and the fourth trunnion 124 can be rigidly connected to the connection link 125, and the arm 120 can be configured to rotate relative to the connection link 125. In some other embodiments, the first bearing surface 115 and the third trunnion 123 can be configured to rotate with respect to one another, the second bearing surface 116 and the fourth trunnion 124 can be configured to rotate with respect to one another, the third trunnion 123 and the fourth trunnion 124 can be rigidly connected to the connection link 125, and the arm 120 can be configured to rotate relative to the connection link 125.

In some embodiments, the mechanical joint can include a first bearing cap 141 and a second bearing cap 142. In some embodiments, the first bearing cap 141 and the second bearing cap 142 can be configured to be releasably attached to the gimbal table 110. In some embodiments, the first bearing cap 141 can be engaged with the third trunnion 123 and can be attached to the upper surface 114 of the gimbal table 110. In some embodiments, the second bearing cap 142 can be engaged with the fourth trunnion 124 and can be attached to the upper surface 114 of the gimbal table 110. In some embodiments, the first bearing cap 141 can be configured to maintain the third trunnion 123 in an engaged position with the first bearing surface 115 and the second bearing cap 142 can be configured to maintain the fourth trunnion 124 in an engaged position with the second bearing surface 116 such that movement of the third trunnion 123 and the fourth trunnion 124 can be restricted in a linear direction, e.g., in a direction parallel with the first axis 131 and/or in a direction parallel with the second axis 132 and/or in a direction normal to the upper surface 114 of the gimbal table 110.

In some embodiments, the first bearing cap 141 and the second bearing cap 142 can be configured to be attached to the gimbal table 110 via a plurality of mechanical fasteners 143, for example threaded cap screws. In some embodiments, the first bearing cap 141 can define a bearing surface or third bearing surface 144 that can be configured to rotatively engage with the third trunnion 123 and the second bearing cap 142 can define a bearing surface or fourth bearing surface 145 that can be configured to rotatively engage with the fourth trunnion 124. In some embodiments, the third bearing surface 144 and the fourth bearing surface 145 can each have a semi-circular cross-section when secured to the gimbal table 110 and viewed along the first axis 131. In such embodiments, a central axis of the third bearing surface 144 and a central axis of the fourth bearing surface 145 can be aligned or colinear with the first axis 131. In some embodiments, when the first bearing cap 141 is secured to the gimbal table 110, the third bearing surface 144 and the first bearing surface 115 can form a bearing surface that can have a semi-circular cross-section. In some embodiments, when the second bearing cap 142 is secured to the gimbal table 110, the fourth bearing surface 145 and the second bearing surface 116 can form a bearing surface that can have a circular cross-section.

In other embodiments, when the first bearing cap 141 and the second bearing cap are secured to the gimbal table 110, the third bearing surface 144 and the fourth bearing surface 145 can have a non-circular cross-section when viewed along the first axis 131. In such embodiments, the third bearing surface 144 and the fourth bearing surface 145 can have a non-circular cross-sectional shape, for example an oval, a non-circular ellipse-shaped cross-section, a triangular shaped cross-section, a rectangular-shaped cross-section, a pentagonal-shaped cross-section, or any other non-circular cross-section when viewed along the second axis 132.

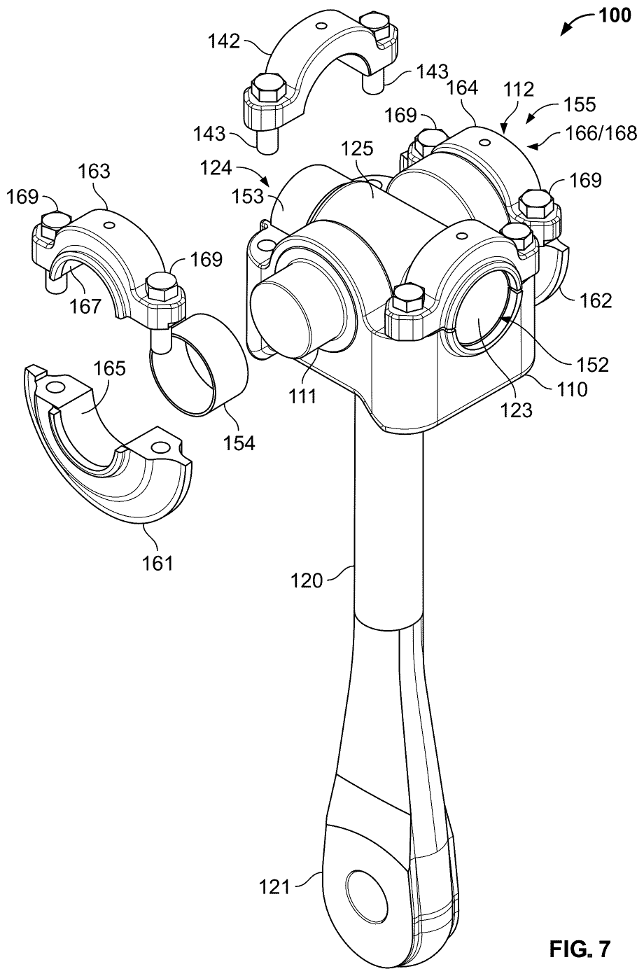

FIG. 7 depicts an exploded view of the mechanical joint 100 depicted in FIGS. 1 and 2 that further includes a first and a second bearing block 161, 162 and corresponding bearing caps, i.e., a third bearing cap 162 and a fourth bearing cap 164, according to one or more embodiments. In some embodiments, the first bearing block 161 and the second bearing block 162 can be disposed on or attached to the first member, for example a turret mooring system, or a hull of a vessel. In some embodiments, the first bearing block 161 and the second bearing block 162 can each be aligned along the second axis 132 and can be fixedly attached, for example welded or bolted, to the first member. In some embodiments, the first bearing block 161 can define a bearing surface or fifth bearing surface 165 and the second bearing block 162 can define a bearing surface or sixth bearing surface 166. In some embodiments, the fifth bearing surface 165 can be disposed or formed on the first bearing block 161. In some embodiments, the sixth bearing surface 166 can be disposed or formed on the second bearing block 162. In some embodiments, the fifth bearing surface 165 and the sixth bearing surface 166 can have a semi-circular cross-section when viewed along the second axis 132. In such embodiments, a central axis of the fifth bearing surface 165 and a central axis of the sixth bearing surface 166 can be aligned or colinear with the second axis 132. In some embodiments, the fifth bearing surface 165 can be configured to rotatively engage with the first trunnion 111 and the sixth bearing surface can be configured to rotatively engage with the second trunnion 112.

In some embodiments, the third bearing cap 163 can be configured to be releasably attached to the first bearing block 161 and the fourth bearing cap 164 can be configured to be releasably attached to the second bearing block 162. In some embodiments, the third bearing cap 163 can be configured to maintain the first trunnion 111 in an engaged position with the fifth bearing surface 165 and the fourth bearing cap 164 can be configured to maintain the second trunnion 112 in an engaged position with the sixth bearing surface 166 such that movement of the first trunnion 111 and the second trunnion 112 can be restricted in a linear direction, e.g., in a direction parallel with the first axis 131 and/or in a direction parallel with the second axis 132 and/or in a direction normal to the upper surface 114 of the gimbal table 110. In some embodiments, the third bearing cap 163 can be configured to be attached to the first bearing block 161 and the fourth bearing cap 164 can be configured to be attached to the second bearing block 162 via a plurality of mechanical fasteners 169, for example threaded cap screws 169.

In some embodiments, the third bearing cap 163 can define a bearing surface or seventh bearing surface 167 and the fourth bearing cap 164 can define a bearing surface or eighth bearing surface 168. In some embodiments, the seventh bearing surface 167 and the eighth bearing surface 168 can have a semi-circular cross-section when viewed along the first axis 131. In such embodiments, a central axis of the seventh bearing surface 167 and a central axis of the eighth bearing surface 168 can be aligned or colinear with the first axis 131. In some embodiments, when the third bearing cap 163 is secured to the first bearing block 161, the fifth bearing surface 165 and the seventh bearing surface 167 can form a bearing surface that can have a circular cross-section. In some embodiments, when the fourth bearing cap 164 is secured to the second bearing block 162, the sixth bearing surface 166 and the eighth bearing surface 168 can form a bearing surface that can have a circular cross-section.

In some embodiments, as depicted in FIGS. 2 and 7, the mechanical joint 100 can include a first bushing 152 disposed between the third trunnion 123 and the first and third bearing surfaces 115, 144, and a second bushing 153 disposed between the fourth trunnion 124 and the second and fourth bearing surfaces 116, 145. In some embodiments, the mechanical joint 100 can include a third bushing 154 disposed between the first trunnion 111 and the fifth and seventh bearing surfaces 165, 167 and a fourth bushing 155 disposed between the second trunnion 112 and the sixth and eight bearing surfaces 166, 168. In some embodiments, the mechanical joint 100 can include a fifth bushing disposed between an external surface of the connection link 125 and an internal surface of a bore that can be defined by second end 122 of the arm 120. As used herein, the term “bushing” refers to any sleeve, shim, liner, inlay, pad, or any other structure configured to reduce friction and/or wear between an outer surface of a trunnion or cylinder or other structure, and an inner surface of a bore the trunnion or cylinder is at least partially disposed within. The first bushing 152, second bushing 153, third bushing 154, fourth bushing 155, and/or fifth bushing can be manufactured from bronze, brass, a polymer, a fiber reinforced composite material, or any other suitable material.

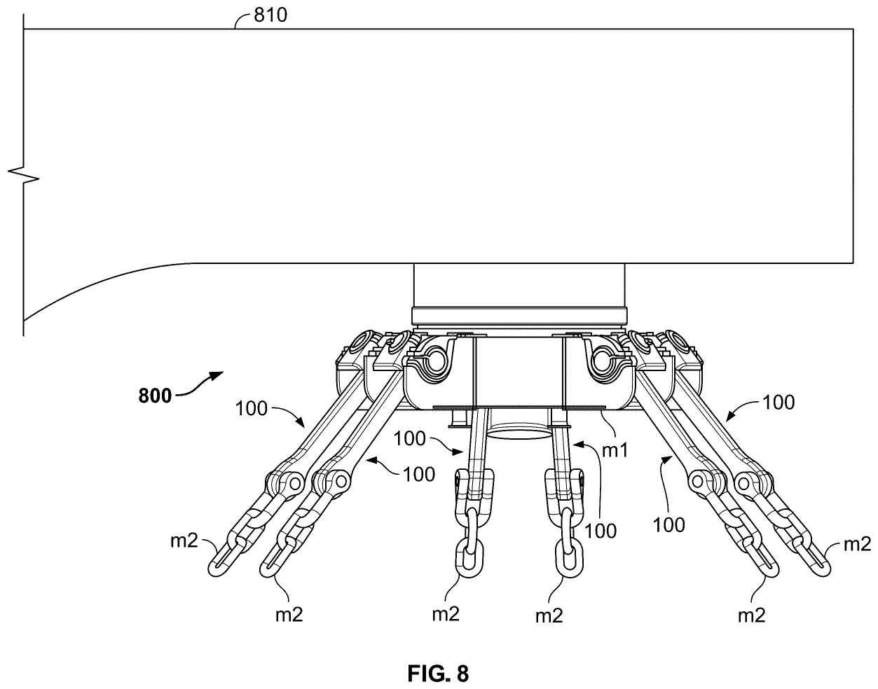

FIG. 8 depicts a turret mooring system 800 disposed on a vessel 810 that includes a plurality of mechanical joints 100 linking a first member M1 to a second member M2. In this embodiment, the turret mooring system 800 includes the first member M1 that is configured as a chain table of the turret mooring system 800 and plurality of second members M2 that are configured as chain legs of the turret mooring system 800. In some embodiments, a process for connecting a first member M1 to a second member using the mechanical joint 100 depicted in FIGS. 1 to 7 can include: providing the mechanical joint 100 and installing the mechanical joint 100 on the first member M 1 . In some embodiments, the process can further include connecting the second member M2 to the first end 121 of the arm 120.

The present disclosure further relates to any one or more of the following numbered embodiments:

A1. A mechanical joint configured to provide an articulated connection between a first member and a second member, comprising: a gimbal table that defines an aperture therethrough, wherein an upper surface of the gimbal table defines a first bearing surface and a second bearing surface on a first pair of opposing sides of the gimbal table; a first trunnion and a second trunnion disposed on a second pair of opposing sides of the gimbal table; and an arm having a first end and a second end, wherein a third trunnion and a fourth trunnion are each disposed toward the second end of the arm, wherein: the third trunnion and the fourth trunnion are aligned with a first axis, the first trunnion and the second trunnion are aligned with a second axis, the first axis and the second axis are substantially orthogonal or substantially perpendicular with respect to one another, the third trunnion and the first bearing surface are engaged with one another, the fourth trunnion and the second bearing surface are engaged with one another, the arm is rotatable relative to the gimbal table about the first axis, and at least a portion of the arm is disposed through the aperture defined by the gimbal table.

A2. The mechanical joint of paragraph A1, further comprising a connection link disposed on the arm toward the second thereof, wherein the third trunnion and the fourth trunnion are attached to the arm via the connection link

A3. The mechanical joint of paragraph A2, wherein: the second end of the arm defines a bore therethrough that is aligned with the first axis, the connection link is disposed through the bore defined by the second end of the arm, and the third trunnion and the fourth trunnion are rigidly connected to the connection link.

A4. The mechanical joint of paragraph A2 or paragraph A3, wherein the connection link is rotatively connected to the arm.

A5. The mechanical joint of paragraph A3 or paragraph A4, further comprising a bushing disposed between the connection link and a surface of the bore defined by the second end of the arm.

A6. The mechanical joint of paragraph A2, wherein: the connection link is rigidly connected to the arm, the third trunnion and the first bearing surface are rotatively engaged with one another, and the fourth trunnion and the second bearing surface are rotatively engaged with one another.

A7. The mechanical joint of any one of paragraphs A1 to A6, further comprising a first bearing cap and a second bearing cap, wherein: the first bearing cap is engaged with the third trunnion and attached to the upper surface of the gimbal table, and the second bearing cap is engaged with the fourth trunnion and attached to the upper surface of the gimbal table.

A8. The mechanical joint of paragraph A7, further comprising a first bushing disposed between the third trunnion and the first bearing surface and a third bearing surface defined by the first bearing cap, and a second bushing disposed between the fourth trunnion and the second bearing surface and a fourth bearing surface defined by the second bearing cap.

A9. The mechanical joint of any one of paragraphs A1 to A8, further comprising a first bearing block and a second bearing block configured to be disposed on the first member, wherein the first trunnion is configured to rotatively engage with the first bearing block and the second trunnion is configured to rotatively engage with the second bearing block.

A10. The mechanical joint of paragraph A9, further comprising a third bearing cap attached to the first bearing block and a fourth bearing cap attached to the second bearing block.

A11. The mechanical joint of paragraph A10, wherein the third bearing cap is rotatively engaged with the first trunnion and the fourth bearing cap is rotatively engaged with the second trunnion.

A12. The mechanical joint of paragraph A10 or paragraph A11, further comprising a third bushing disposed between the first trunnion and a bearing surface defined by the first bearing block and a bearing surface defined by the third bearing cap, and a fourth bushing disposed between the second trunnion and a bearing surface defined by the second bearing block and a bearing surface defined by the fourth bearing cap.

A13. The mechanical joint of any one of paragraphs A1 to A12, wherein the first end of the arm is configured to connect to the second member.

A14. The mechanical joint of any one of paragraphs A1 to A13, wherein the first member is a vessel.

A15. The mechanical joint of any one of paragraphs A1 to A14, wherein the second member is a mooring leg.

B1. A mechanical joint configured to provide an articulated connection between a first member and a second member, comprising: a first bearing block and a second bearing block configured to be disposed on the first member; a gimbal table that defines an aperture therethrough, wherein an upper surface of the gimbal table defines a first bearing surface and a second bearing surface on a first pair of opposing sides of the gimbal table; a first trunnion and a second trunnion disposed on a second pair of opposing sides of the gimbal table; an arm having a first end and a second end, wherein a third trunnion and a fourth trunnion are each disposed toward the second end of the arm; a first bearing cap configured to be engaged with the third trunnion and configured to be attached to the upper surface of the gimbal table; a second bearing cap configured to be engaged with the fourth trunnion and configured to be attached to the upper surface of the gimbal table; a third bearing cap configured to be secured to the first bearing block; and a fourth bearing cap configured to be secured to the second bearing block, wherein: the third trunnion and the fourth trunnion are aligned with a first axis, the first trunnion and the second trunnion are aligned with a second axis, the first axis and the second axis are substantially orthogonal or substantially perpendicular with respect to one another, the third trunnion and the first bearing surface are engaged with one another, the fourth trunnion and the second bearing surface are engaged with one another, the arm is rotatable relative to the gimbal table about the first axis, at least a portion of the arm is disposed through the aperture defined by the gimbal table, and the first trunnion is configured to rotatively engage with the first bearing block and the second trunnion is configured to rotatively engage with the second bearing block.

B2. The system of paragraph B1, wherein the first member is a vessel.

B3. The system of paragraph B1 or paragraph B2, wherein the second member is a mooring leg.

B4. The system of any one of paragraphs B1 to B3, wherein the second member is configured to connect to the first end of the arm.

C1. A process for connecting a first member to a second member, comprising: providing a mechanical joint, wherein the mechanical joint comprises: a first bearing block and a second bearing block configured to be disposed on the first member; a gimbal table that defines an aperture therethrough, wherein an upper surface of the gimbal table defines a first bearing surface and a second bearing surface on a first pair of opposing sides of the gimbal table; a first trunnion and a second trunnion disposed on a second pair of opposing sides of the gimbal table; an arm having a first end and a second end, wherein a third trunnion and a fourth trunnion are each disposed toward the second end of the arm; a first bearing cap engaged with the third trunnion and attached to the upper surface of the gimbal table; a second bearing cap engaged with the fourth trunnion and attached to the upper surface of the gimbal table; a third bearing cap secured to the first bearing block; and a fourth bearing cap secured to the second bearing block, wherein: the third trunnion and the fourth trunnion are aligned with a first axis, the first trunnion and the second trunnion are aligned with a second axis, the first axis and the second axis are substantially orthogonal or substantially perpendicular with respect to one another, the third trunnion and the first bearing surface are engaged with one another, the fourth trunnion and the second bearing surface are engaged with one another, the arm is rotatable relative to the gimbal table about the first axis, at least a portion of the arm is disposed through the aperture defined by the gimbal table, and the first trunnion is configured to rotatively engage with the first bearing block and the second trunnion is configured to rotatively engage with the second bearing block; and installing the mechanical joint on the first member.

C2. The process of paragraph C1, further comprising attaching the second member to the first end of the arm.

C3. The process of paragraph C1 or paragraph C2, wherein the first member is a vessel.

C4. The process of any one of paragraphs C1 to C3, wherein the second member is a mooring leg.

C5. The process of any one of paragraphs C1 to C4, wherein installing the mechanical joint on first member comprises attaching the first bearing block and the second bearing block to the first member.

C6. The process of any one of paragraphs C1 to C5, wherein the mechanical joint further comprises a connection link disposed on the arm toward the second thereof, wherein the third trunnion and the fourth trunnion are attached to the arm via the connection link

C7. The process of any one of paragraphs C1 to C6, wherein the mechanical joint further comprises: a first bushing disposed between the third trunnion and the first bearing surface and a third surface defined by the first bearing cap; a second bushing disposed between the fourth trunnion and the second bearing surface and a fourth bearing surface defined by the second bearing cap; a third bushing disposed between the first trunnion and a fifth bearing surface defined by the first bearing block and a seventh bearing surface defined by the third bearing cap; and a fourth bushing disposed between the second trunnion and a sixth surface defined by the second bearing block and an eighth surface defined by the fourth bearing cap.

Certain embodiments and features have been described using a set of numerical upper limits and a set of numerical lower limits It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A mechanical joint configured to provide an articulated connection between a first member and a second member, comprising:
a gimbal table that defines an aperture therethrough, wherein an upper surface of the gimbal table defines a first bearing surface and a second bearing surface on a first pair of opposing sides of the gimbal table;
a first trunnion and a second trunnion disposed on a second pair of opposing sides of the gimbal table; and
an arm having a first end and a second end, wherein a third trunnion and a fourth trunnion are each disposed toward the second end of the arm, wherein:
the third trunnion and the fourth trunnion are aligned with a first axis,
the first trunnion and the second trunnion are aligned with a second axis,
the first axis and the second axis are substantially orthogonal or substantially perpendicular with respect to one another,
the third trunnion and the first bearing surface are engaged with one another,
the fourth trunnion and the second bearing surface are engaged with one another,
the arm is rotatable relative to the gimbal table about the first axis, and
at least a portion of the arm is disposed through the aperture defined by the gimbal table.

2. The mechanical joint of claim 1, further comprising a connection link disposed on the arm toward the second thereof, wherein the third trunnion and the fourth trunnion are attached to the arm via the connection link

3. The mechanical joint of claim 2, wherein:
the second end of the arm defines a bore therethrough that is aligned with the first axis,
the connection link is disposed through the bore defined by the second end of the arm, and
the third trunnion and the fourth trunnion are rigidly connected to the connection link

4. The mechanical joint of claim 3, wherein the connection link is rotatively connected to the arm.

5. The mechanical joint of claim 3, further comprising a bushing disposed between the connection link and a surface of the bore defined by the second end of the arm.

6. The mechanical joint of claim 2, wherein:
the connection link is rigidly connected to the arm,
the third trunnion and the first bearing surface are rotatively engaged with one another, and
the fourth trunnion and the second bearing surface are rotatively engaged with one another.

7. The mechanical joint of claim 1, further comprising a first bearing cap and a second bearing cap, wherein:
the first bearing cap is engaged with the third trunnion and attached to the upper surface of the gimbal table, and
the second bearing cap is engaged with the fourth trunnion and attached to the upper surface of the gimbal table.

8. The mechanical joint of claim 7, further comprising a first bushing disposed between the third trunnion and the first bearing surface and a third bearing surface defined by the first bearing cap, and a second bushing disposed between the fourth trunnion and the second bearing surface and a fourth bearing surface defined by the second bearing cap.

9. The mechanical joint of claim 1, further comprising a first bearing block and a second bearing block configured to be disposed on the first member, wherein the first trunnion is configured to rotatively engage with the first bearing block and the second trunnion is configured to rotatively engage with the second bearing block.

10. The mechanical joint of claim 9, further comprising a third bearing cap attached to the first bearing block and a fourth bearing cap attached to the second bearing block.

11. The mechanical joint of claim 10, wherein the third bearing cap is rotatively engaged with the first trunnion and the fourth bearing cap is rotatively engaged with the second trunnion.

12. The mechanical joint of claim 11, further comprising a third bushing disposed between the first trunnion and a bearing surface defined by the first bearing block and a bearing surface defined by the third bearing cap, and a fourth bushing disposed between the second trunnion and a bearing surface defined by the second bearing block and a bearing surface defined by the fourth bearing cap.

13. The mechanical joint of claim 1, wherein the first end of the arm is configured to connect to the second member.

14. The mechanical joint of claim 1, wherein the first member is a vessel and the second member is a mooring leg.

15. A mechanical joint configured to provide an articulated connection between a vessel and a mooring leg, comprising:
a first bearing block and a second bearing block configured to be disposed on the vessel;
a gimbal table that defines an aperture therethrough, wherein an upper surface of the gimbal table defines a first bearing surface and a second bearing surface on a first pair of opposing sides of the gimbal table;
a first trunnion and a second trunnion disposed on a second pair of opposing sides of the gimbal table;
an arm having a first end and a second end, wherein a third trunnion and a fourth trunnion are each disposed toward the second end of the arm;
a first bearing cap configured to be engaged with the third trunnion and configured to be attached to the upper surface of the gimbal table;
a second bearing cap configured to be engaged with the fourth trunnion and configured to be attached to the upper surface of the gimbal table;
a third bearing cap configured to be secured to the first bearing block; and
a fourth bearing cap configured to be secured to the second bearing block, wherein:
the third trunnion and the fourth trunnion are aligned with a first axis,
the first trunnion and the second trunnion are aligned with a second axis,
the first axis and the second axis are substantially orthogonal or substantially perpendicular with respect to one another,
the third trunnion and the first bearing surface are engaged with one another,
the fourth trunnion and the second bearing surface are engaged with one another,
the arm is rotatable relative to the gimbal table about the first axis,
at least a portion of the arm is disposed through the aperture defined by the gimbal table, and
the first trunnion is configured to rotatively engage with the first bearing block and the second trunnion is configured to rotatively engage with the second bearing block.

16. A process for connecting a first member to a second member, comprising providing a mechanical joint, wherein the mechanical joint comprises:
a first bearing block and a second bearing block configured to be disposed on the first member;
a gimbal table that defines an aperture therethrough, wherein an upper surface of the gimbal table defines a first bearing surface and a second bearing surface on a first pair of opposing sides of the gimbal table;
a first trunnion and a second trunnion disposed on a second pair of opposing sides of the gimbal table;
an arm having a first end and a second end, wherein a third trunnion and a fourth trunnion are each disposed toward the second end of the arm;
a first bearing cap engaged with the third trunnion and attached to the upper surface of the gimbal table;
a second bearing cap engaged with the fourth trunnion and attached to the upper surface of the gimbal table;
a third bearing cap secured to the first bearing block; and
a fourth bearing cap secured to the second bearing block, wherein:
the third trunnion and the fourth trunnion are aligned with a first axis,
the first trunnion and the second trunnion are aligned with a second axis,
the first axis and the second axis are substantially orthogonal or substantially perpendicular with respect to one another,
the third trunnion and the first bearing surface are engaged with one another,
the fourth trunnion and the second bearing surface are engaged with one another,
the arm is rotatable relative to the gimbal table about the first axis,
at least a portion of the arm is disposed through the aperture defined by the gimbal table, and
the first trunnion is configured to rotatively engage with the first bearing block and the second trunnion is configured to rotatively engage with the second bearing block; and
installing the mechanical joint on the first member.

17. The process of claim 16, further comprising attaching the second member to the first end of the arm.

18. The process of claim 17, wherein the first member is a vessel and the second member is a mooring leg, and wherein installing the mechanical joint on the vessel comprises attaching the first bearing block and the second bearing block to the vessel.

19. The process of claim 16, wherein the mechanical joint further comprises a connection link disposed on the arm toward the second thereof, and wherein the third trunnion and the fourth trunnion are attached to the arm via the connection link

20. The process of claim 16, wherein the mechanical joint further comprises:
a first bushing disposed between the third trunnion and the first bearing surface and a third bearing surface defined by the first bearing cap;
a second bushing disposed between the fourth trunnion and the second bearing surface and a fourth bearing surface defined by the second bearing cap;
a third bushing disposed between the first trunnion and a fifth bearing surface defined by the first bearing block and a seventh bearing surface defined by the third bearing cap; and
a fourth bushing disposed between the second trunnion and a sixth bearing surface defined by the second bearing block and an eighth bearing surface defined by the fourth bearing cap.
